(19) United States
(12) Patent Application Publication
(10) Pub. No.: US 2020/0208760 A1
(43) Pub. Date: Jul. 2, 2020

(54) CONNECTION HAVING BALANCED PIN AND BOX FACE THICKNESS

(71) Applicant: Ultra Premium Services, L.L.C., Houston, TX (US)

(72) Inventor: Nishikant V Raje, Houston, TX (US)

(73) Assignee: Ultra Premium Services, L.L.C., Houston, TX (US)

(21) Appl. No.: 16/728,565

(22) Filed: Dec. 27, 2019

Related U.S. Application Data
(60) Provisional application No. 62/785,549, filed on Dec. 27, 2018.

(51) Int. Cl. F16L 15/00; F16L 15/04

(52) U.S. Cl. CPC F16L 15/004; F16L 15/04

(57) ABSTRACT

A connection includes a first tubular member and a second tubular member. The first tubular member has a pin end with threading and a pin face at an outermost end of the pin end of the first tubular member and the second tubular member has a box end with threading and a box face at an outermost end of the box end of the second tubular member. The first tubular member and the second tubular member are configured to connect when the threading of the pin end engages with the threading of the box end. The thickness of the pin face is substantially identical to the thickness of the box face.

### TECHNICAL FIELD

The present application relates to tubular connections, and more particularly, to a tubular connection having balanced pin and box face thicknesses.

### BACKGROUND

This section is intended to introduce various aspects of art that may be related to various aspects of the present techniques, which are described and/or claimed below. This discussion is believed to be helpful in providing background information to facilitate a better understanding of the various aspects of the present disclosure. Accordingly, it should be understood that these statements are to be read in this light, and not as admissions of prior art. The following descriptions and examples are not admitted to be prior art by virtue of their inclusion in this section.

The oil and gas industry is drilling upstream production wells of increasing depth and complexity to find and produce raw hydrocarbons. The industry routinely uses steel pipe, considered an Oil Country Tubular Good (OCTG) to protect the borehole (i.e., casing) and to control the fluids produced within the pipe (i.e., tubing). Such pipes, including casing and tubing, are made and transported in relatively short segments and installed in the borehole one segment at a time, with each segment being connected to the next. As the search for oil and gas has driven companies to drill deeper wells, pipes may be subject to increased complexity and magnitude of forces throughout their lifespans downhole. Industry demands have grown for casing, tubing, and connectors having increased tensile and pressure strengths. Furthermore, the developing area of deviated and horizontal wells have exacerbated this trend, further adding increased torsional loads as another requirement for casing and tubing connectors.

Connectors have been designed with varying thread, shoulder, and seal configurations. For example, two general connector thread configurations include a threaded and coupled connector and an integral connector. A thread and coupled connector includes a pin (i.e., a male threaded end) machined on relatively long joints of pipe and joined by the box (i.e., a female threaded end) machined on a relatively short coupling. An integral connector includes a pin threaded on a full-length pipe connected to a box threaded to another full-length pipe, and pin and box ends may be threaded onto opposite sides of each full-length pipe segment so that each segment may be connected for a length of a borehole. As industry demands connectors with increasingly high tensile strength, pressure strength, and torque, etc., the features of the pin end and box end connectors may be further designed and engineered to meet downhole performance criteria.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one embodiment, a connection includes a first tubular member and a second tubular member. The first tubular member has a pin end with threading and a pin face at an outermost end of the pin end of the first tubular member and the second tubular member has a box end with threading and a box face at an outermost end of the box end of the second tubular member. The first tubular member and the second tubular member are configured to connect when the threading of the pin end engages with the threading of the box end. The thickness of the pin face is substantially identical to the thickness of the box face.

### BRIEF DESCRIPTION OF THE DRAWINGS

Embodiments of the present techniques are described with reference to the following figures. The same numbers are used throughout the figures to reference like features and components. Various embodiments may utilize elements and/or components other than those illustrated in the drawings, and some elements and/or components may not be present in various embodiments. Elements and/or components in the figures are not necessarily drawn to scale.

FIG. 1 is a partial cross-section of a pin end and box end in a typical semi-flush connection;

FIG. 2 is a partial cross-section of a pin end and box end in a typical flush connection;

FIG. 3 is a partial cross-section of a pin end and box end in a semi-flush connection having balanced face thicknesses in accordance with embodiments of the present techniques; and

FIG. 4 is a partial cross-section of a pin end and box end in a flush connection having balanced face thicknesses in accordance with embodiments of the present techniques.

### DETAILED DESCRIPTION

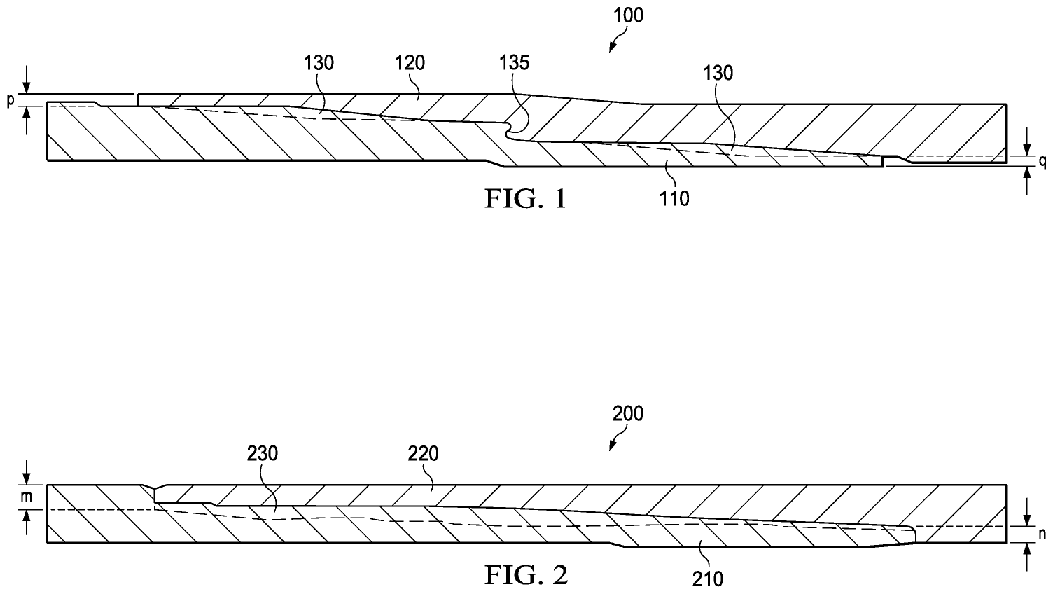

FIG. 1 is a partial cross-section of a pin end 110 and box end 120 in a typical semi-flush connection 100. A typical semi-flush connection is made between a pin end 110 on one length of pipe and a box end 120 on a second length of pipe. Each of the pin end 110 and box end 120 has threading 130 (not shown in detail), and when the connection is made up (i.e., connected together, screwed together, locked, etc.), the pin end threading mates with the box end threading. The connection may also have a seal, such as the center seal 135 depicted in FIG. 1. Other sealing may include a curvilinear seal, such as a sphere-on-sphere seal or a sphere-on-cone seal, or other types of metal-to-metal seals. The pin end 110 and box end 120 also have a face at the end of the pipe. A semi-flush connection, as depicted in FIG. 1, may be so named because the box face may slightly protrude in an axial dimension from the body of the pipe having the pin end 110. In typical semi-flush connections, a thickness of the face of the box end, represented by ‘p’ in FIG. 1, may be different from a thickness of the face of the pin end, represented by ‘q’ in FIG. 1. For example, the box face thickness ‘p’ is typically greater than the pin face thickness ‘q.’ This may result in different internal and external pressure ratings. In some typical designs, the external pressure rating may be greater than the internal pressure rating.

FIG. 2 is a partial cross-section of a pin end 210 and box end 220 in a typical flush connection 200. Similar to the semi-flush connection shown in FIG. 1, the typical flush connection may also be made between a pin end 210 on one length of pipe and a box end 220 on a second length of pipe. Each of the pin end 210 and box end 220 has threading 230, and when the connection is made up, the pin end threading mates with the box end threading. Flush joint connections may also have a seal, although one is not shown in FIG. 2. The pin end 210 and box end 220 also have a face at the end of the pipe. A flush connection may be so named because the box edge may be flush with the body of the pipe having the pin end. In typical flush connections, a thickness of the face of the box end may be different from a thickness of the face of the pin end. For example, the box face thickness may be greater than the pin face thickness, or the pin face thickness may be greater than the box face thickness. This may result in different internal and external pressure ratings.

In one or more embodiments of the present disclosure, the box face thickness may be substantially identical to the pin face thickness. Connections having similar pin and box face thicknesses may create a symmetrical design for the box end and pin end, resulting in a similar internal and external pressure rating. Connections having similar internal and external pressure ratings may be particularly suitable for certain wells. Moreover, a connection assembly having similar pin and box face thicknesses may be more balanced and rigid, resulting in better overall connection performance, including increased strength and torque capabilities.

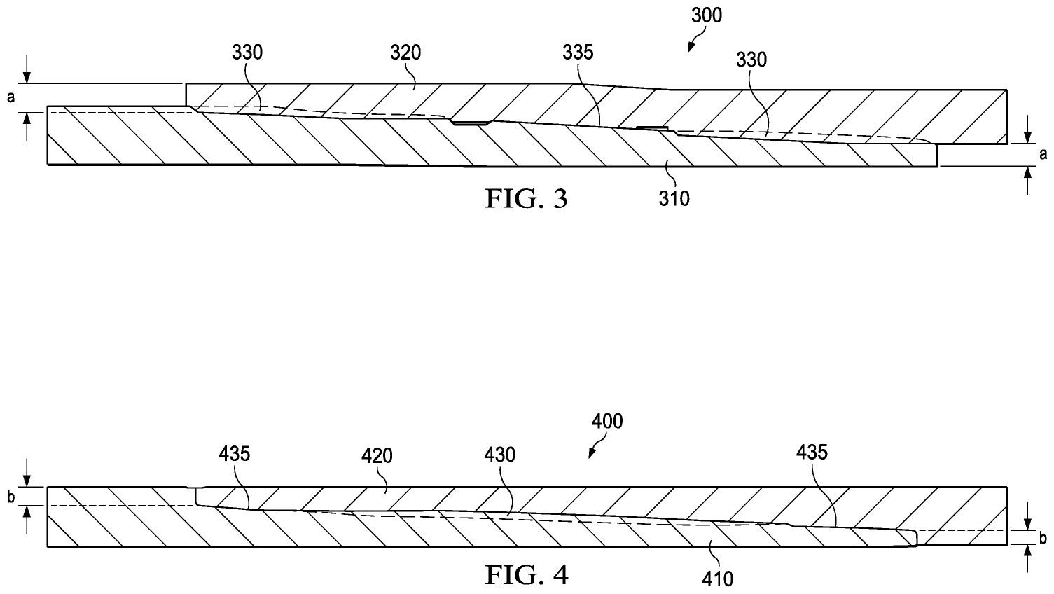

FIG. 3 is a partial cross-section of a pin end 310 and box end 320 in a semi-flush connection 300 having balanced face thicknesses. The semi-flush connection is made between a pin end 310 on one length of pipe and a box end 320 on a second length of pipe. Each of the pin end 310 and box end 320 has threading 330, and when the connection is made up, the pin end threading mates with the box end threading. The connection may also have a seal, such as the curvilinear seal 335 depicted in FIG. 3. The face thickness of the pin end 310 of the connection, represented by ‘a’ in FIG. 3, may be substantially identical to the face thickness of the box end of the connection, represented by ‘a’ in FIG. 3.

Similarly, FIG. 4 is a partial cross-section of a pin end 410 and box end 420 in a flush connection having balanced face thicknesses. The flush connection may be made between a pin end 410 on one length of pipe and a box end 420 on a second length of pipe. Each of the pin end 410 and box end 420 has threading 430, and when the connection is made up, the pin end threading mates with the box end threading. In accordance with the present techniques, the face thickness of the pin end 410 of the connection, represented by ‘b’ in FIG. 4, may be substantially identical to the face thickness of the box end 420 of the connection, represented by ‘b’ in FIG. 4. The connection may also have a seal, such as seals 435 near or adjacent to the pin and box faces depicted in FIG. 4.

Typically, pin and box face thicknesses are outputs of the design of a threaded connection and are determined based on other factors that serve as the inputs to the design, such as, but not limited to, the type of connection (e.g., flush versus semi-flush), the pipe thickness, the internal drift diameter, the connection length, the threadform and taper, and the connection seals. In such designs, the primary design consideration for the pin and box face thicknesses is that the dimension is sufficient to meet minimum requirements.

By requiring that the pin and box face thickness be equal in the design, the thicknesses become inputs to the design. For example, in designing semi-flush connections, the thickness of face the box may not be limited by any physical constraints. The outer diameter of the box of a semi-flush connection is necessarily greater than the nominal outer diameter of the pipe, because the connection is not flush. For this reason, as mentioned above, the box face thickness is often greater than the pin face thickness. The box of a connection is often swaged more than the pin of a connection as well, which also leads to designs with greater box face thicknesses than pin face thicknesses.

In designing a balanced connection, however, a thicker box face would be balanced with a thicker pin face, and a thicker pin face could impinge the inner drift diameter, which would not be an allowable design. But reducing the box face thickness to simply match the pin face thickness would limit the box face thickness compared with an unbalanced design. A thinner box face thickness would affect the hoop stresses and could affect the ability to handle the connection in the field. A balanced design thus takes into consideration the above issues.

Due to the balanced design of the pin and box ends in the present disclosure, both pin and box ends may have similar axial performance properties. In addition to having similar internal and external pressure ratings, having balanced critical sections for both box and pin, and having a more balanced and rigid connection with increased strength and torque capabilities, the balanced pin and box connection may also have increased performance predictability. Designing a well with connections having balanced pin and box face thicknesses may be more straightforward since the pin and box ends may have similar axial performance properties.

Many modifications and other implementations set forth herein will be apparent having the benefit of the teachings presented in the foregoing descriptions and the associated drawings. Therefore, it is to be understood that the systems and methods described herein are not to be limited to the specific implementations disclosed and that modifications and other implementations are intended to be included within the scope of the appended claims. Although specific terms are employed herein, they are used in a generic and descriptive sense and not for purposes of limitation.

1. A connection comprising:
a first tubular member having a pin end comprising threading and a pin face at an outermost end of the pin end of the first tubular member; and
a second tubular member having a box end comprising threading and a box face at an outermost end of the box end of the second tubular member;
wherein the first tubular member and the second tubular member are configured to connect when the threading of the pin end engages with the threading of the box end; and
wherein a thickness of the pin face is substantially identical to a thickness of the box face.

2. The connection of claim 1, wherein the outer diameter of the box end is substantially identical to the outer diameter of the pin end.

3. The connection of claim 1, wherein the outer diameter of the box end is larger than the outer diameter of the pin end.

4. The connection of claim 1, wherein the pin end of the first tubular member has been swaged to reduce the inner diameter of the pin end.

5. The connection of claim 1, wherein the box end of the second tubular member has been swaged to expand the outer diameter of the box end.

6. The connection of claim 1, wherein the pin end of the first tubular member comprises a seal element, and wherein the box end of the second tubular member comprises a seal element.

7. The connection of claim 6, wherein the seal element of the pin end of the first tubular member is a center seal element, and wherein the seal element of the box end of the second tubular member is a center seal element.

8. The connection of claim 6, wherein the seal of the pin end of the first tubular member is a curvilinear seal element, and wherein the seal of the box end of the second tubular member is a curvilinear seal element.

9. The connection of claim 1, wherein the pin end of the first tubular member comprises a seal element, wherein the box end of the second tubular member comprises a seal element, and where in one seal element is a curvilinear surface and the other seal element is a linear surface.

10. A tubular member comprising:
a pin end comprising threading and a pin face at an outermost end of the pin end; and
a box end comprising threading and a box face at an outermost end of the box end,
wherein a thickness of the pin face is substantially identical to a thickness of the box face.

11. The tubular member of claim 10,
wherein the pin end of the tubular member is configured to connect to a box end of a second tubular member when the threading of the pin end of the tubular member engages with the threading of the box end of the second tubular member; and
wherein the box end of the tubular member is configured to connect to a pin end of a third tubular member when the threading of the box end of the tubular member engages with the threading of the pin end of the third tubular member.

12. The tubular member of claim 10, wherein the outer diameter of the box end is substantially identical to the outer diameter of the pin end.

13. The tubular member of claim 10, wherein the outer diameter of the box end is larger than the outer diameter of the pin end.

14. The tubular member of claim 10, wherein the pin end of the first tubular member has been swaged to reduce the inner diameter of the pin end.

15. The tubular member of claim 10, wherein the box end of the second tubular member has been swaged to expand the outer diameter of the box end.

16. The connection of claim 10, wherein the pin end comprises a seal element, and wherein the box end comprises a seal element.

17. The connection of claim 16, wherein the seal element of the pin end is a center seal element, and wherein the seal element of the box end is a center seal element.

18. The connection of claim 16, wherein the seal of the pin end is a curvilinear seal, and wherein the seal of the box end is a curvilinear seal.

19. The connection of claim 1, wherein the pin end comprises a seal element, wherein the box end comprises a seal element, and where in one seal element comprises a curvilinear surface and the other seal element comprises a linear surface.

20. The connection of claim 10, wherein the pin end comprises a seal element adjacent to the pin face, and wherein the box end comprises a seal element adjacent to the box face.
